(19) United States
(12) Patent Application Publication
(10) Pub. No.: US 2006/0068845 A1
(43) Pub. Date: Mar. 30, 2006

(54) Sim-card for operation with a terminal of a communication network

(76) Inventors: Dietmar Muller, Bonn (DE); Georg Steimel, Bonn (DE)

Correspondence Address: THE MAXHAM FIRM, 750 "B" STREET, SUITE 3100, SAN DIEGO, CA, 92101, US

(21) Appl. No.: 10/530,070

(22) PCT Filed: Sep. 30, 2003
(86) PCT No.: PCT/DE03/03269

§ 371 Date: Aug. 29, 2005

(30) Foreign Application Priority Data
Oct. 1, 2002 (DE) 102 46 124.4

(51) Int. Cl. H04B 1/38

(52) U.S. Cl. 455/558

(57) ABSTRACT

The invention relates to a SIM card for operation with a terminal of a communication network, characterised in being embodied as a telematic SIM card such that only connections to fixed target and/or source addresses may be generated using the terminal.

### BACKGROUND OF THE INVENTION

1. Field of the Invention

The invention pertains to a SIM card for operation with a terminal device of a mobil communications network.

2. Discussion of Prior Art

In mobile communication networks, so-called Telematic services are well known. Telematic services are basically machine-to-machine connections or applications, wherein Telematic applications include vehicle services as well as services in machines. The purpose of these applications is basically to record events and measured data and to regulate and control corresponding processes. Moreover, these services are, in general, performed automatically, that is, without human intervention.

Examples of Telematic services in vehicles are:
Emergency services;
Roadside assistance service;
Remote control/remote access;
Remote vehicle diagnostics;
Vehicle tracking; and
Vehicle data recording.

Examples of Telematic services in machines are:
Recording of counter status;
Recording of fill levels;
Recording of states and controls;
Remote diagnostics; and
Software download.

The information exchange needed for this service can be accomplished through mobile communication networks.

All of these Telematic services are characterized in that in general the communication that takes place is between two fixed communication partners. The media used for the transfer can be DTMF, SMS, GSM-CSD, GPRS, and UMTS according to prior art, language, and signaling channels.

### SUMMARY OF THE INVENTION

A purpose of this invention is to provide a SIM card for operation in a terminal device of a mobile communication network that, in particular, best supports Telematic services.

An important feature of the invention is that the SIM card can only establish connections to fixed destination addresses or can only be solicited by fixed source addresses, or both. It is advantageous that the SIM card is designed as a special Telematic SIM card.

The mobile phone subscriber relationship can, for example, be operated exclusively within a defined virtual private network (VPN). To accomplish this, the permissible source-destination relationships are stored in the SIM card or stored in a database in the intelligent network. A communication relationship from and to subscribers outside the VPN is fundamentally impossible.

### DETAILED DESCRIPTION OF THE PREFERRED EMBODIMENTS

According to the invention, the necessary administration processes for the issuance of the Telematic SIM card must be set up, which preferably can be provided with the following characteristics:
1. Testing the destination and source addresses in the form of a phone number, URL (Uniform Resource Locator), or APN (Access Point Name), with which the Telematic SIM card is allowed to communicate.
2. Tailoring of addresses and numbers thereof; this must be done both service-specific and country-specific.
3. Countrywide availability of this SIM.
4. Common functions of a standard SIM (such as call forwarding, default available service number) must be excluded.
5. Simplified billing process.

Through these characteristics, it is guaranteed that these cards can be used only for the service for which they are intended, and from and to the defined source and destination addresses.

Misuse is prevented this way. Moreover, this SIM card offers the possibility of implementing other communication services for other users.

In a special version, it is also possible to put limits on other services that typically are not necessarily understood as Telematik services. This is done by providing only services that require a fixed number of addresses.

This limiting of use of the SIM card to defined source and destination addresses can be realized using various components in a mobile transmission chain:
Via the card;
Via the terminal device; and
Via the mobile phone network.

The disadvantage of checking the destination and source addresses in the SIM card or in the terminal device is that prior to establishing a connection, only outgoing connections from the terminal device to the network can be checked for correctness with regard to permissible addresses. Incoming connections can be checked for reliability using a so-called CLIP function (Calling Line Identification Presentation) which is an option in the communication networks, wherein the address (telephone number) of the incoming caller is transferred to the person being called. Moreover, hidden within the implementation via the terminal device is a means to cheat since the terminal device's FDN functionality (Fix Dialing Number), which limits calls to specific destination and source addresses, were not implemented error-free by all devices.

In contrast, it is possible to limit the ability to be reached and to limit destination addresses in an IN-capable (Intelligent Network) mobile phone network, for example, via CAMEL (Customized Application Mobile Enhanced Logic). Essentially, what happens in CAMEL is a combination of GSM and Intelligent Network (IN) technologies. The fundamental concept of IN for flexible implementation, introduction, and control of services in public networks is based on the separation of switching functionalities into basic call switching (Service Switching Point (SSP)) and a centralized service control unit (Service Control Point (SCP)), which communicate with the generic Intelligent Network Application Part (INAP) protocol via SS#7. This allows centralized, flexible, and fast introduction of new services. GSM already exhibits a few parallels to the intelligent network. Although neither IN terminology nor IN protocol, namely SS#7 INAP, is used in GSM, the structure of the network corresponds to the philosophy of the IN. The subdivision of the GSM mobile network into functional units such as MSC and HLR and the logical use of SS#7 and development of MAP are similar to the subdivision of IN for units that communicate via INAP, such as SSP and SCP. The philosophy of CAMEL is to structure service implementations in GSM similar to the process in IN.

In this embodiment of the invention, the addresses solicited by the terminal device are first checked within the network regarding their reliability. This technology also allows incoming connections to be checked for reliability prior to the actual connection establishment.

Here, it is recommended that the assignment of customer profiles and their associated services be maintained with the allowed destination and source addresses through corresponding databases.

The range of subscriber relationship options, which was previously limited, can be expanded for third parties and for the billing thereof through subscription of these third parties. This means that two or more different users (contractual partners) could use the same SIM card physically for incoming and outgoing connections. The use itself is assigned to the respective contractual partner according to the originator principle. Thus, according to this principle, multiple SIM card usage rights are billed and administered.

1-10. (canceled)

11. A SIM card for operation with a terminal device of a mobile telecommunication network, comprising:
the terminal device configured to only establish connections to fixed destination or source addresses, or both;
the destination and source addresses permissible in connection with the SIM card are stored in a memory of the SIM card or in a database of the mobile communication network.

12. The SIM card according to claim 11, wherein said SIM card is designed as a Telematic SIM card.

13. The SIM card according to claim 11, wherein the destination and source addresses are phone numbers, URLs (Uniform Resource Locator) or APN's (Access Point Name).

14. The SIM card according to claim 12, wherein the destination and source addresses are phone numbers, URLs (Uniform Resource Locator) or APN's (Access Point Name).

15. The SIM card according to claim 11, wherein the SIM card only supports defined telecommunication services.

16. The SIM card according to claim 12, wherein the SIM card only supports defined telecommunication services.

17. The SIM card according to claim 13, wherein the SIM card only supports defined telecommunication services.

18. The SIM card according to claim 14, wherein the SIM card only supports defined telecommunication services.

19. The SIM card according to claim 11, wherein the mobile phone subscriber relationship associated with the SIM card can only be operated within a defined virtual private network (VPN).

20. The SIM card according to claim 12, wherein the mobile phone subscriber relationship associated with the SIM card can only be operated within a defined virtual private network (VPN).

21. The SIM card according to claim 13, wherein the mobile phone subscriber relationship associated with the SIM card can only be operated within a defined virtual private network (VPN).

22. The SIM card according to claim 14, wherein the mobile phone subscriber relationship associated with the SIM card can only be operated within a defined virtual private network (VPN).

23. The SIM card according to claim 15, wherein the mobile phone subscriber relationship associated with the SIM card can only be operated within a defined virtual private network (VPN).

24. The SIM card according to claim 11, wherein the SIM card encompasses more than one different subscriber relationship, wherein the use of the SIM card is assigned according to the originator principle to the respective subscriber relationship.

25. The SIM card according to claim 12, wherein the SIM card encompasses more than one different subscriber relationship, wherein the use of the SIM card is assigned according to the originator principle to the respective subscriber relationship.

26. The SIM card according to claim 13, wherein the SIM card encompasses more than one different subscriber relationship, wherein the use of the SIM card is assigned according to the originator principle to the respective subscriber relationship.

27. The SIM card according to claim 14, wherein the SIM card encompasses more than one different subscriber relationship, wherein the use of the SIM card is assigned according to the originator principle to the respective subscriber relationship.

28. The SIM card according to claim 15, wherein the SIM card encompasses more than one different subscriber relationship, wherein the use of the SIM card is assigned according to the originator principle to the respective subscriber relationship.

29. The SIM card according to claim 16, wherein the SIM card encompasses more than one different subscriber relationship, wherein the use of the SIM card is assigned according to the originator principle to the respective subscriber relationship.

30. The SIM card according to claim 11, wherein the SIM card supports other services that are typically not understood to be Telematic services.

31. The SIM card according to claim 12, wherein the SIM card supports other services that are typically not understood to be Telematic services.

32. The SIM card according to claim 13, wherein the SIM card supports other services that are typically not understood to be Telematic services.

33. The SIM card according to claim 14, wherein the SIM card supports other services that are typically not understood to be Telematic services.

34. The SIM card according to claims 15, wherein the SIM card supports other services that are typically not understood to be Telematic services.

35. A process of limited use of a mobile telecommunications network by a terminal device, the process comprising:
using a SIM card in the terminal device;
said card only allowing connections by means of said card only to fixed destination or source addresses, or both; wherein
the destination and source addresses permissible in connection with the SIM card are stored in a memory of the SIM card or in a database of the mobile communication network.
